(19) United States
(12) Patent Application Publication
(10) Pub. No.: US 2004/0121047 A1
(43) Pub. Date: Jun. 24, 2004

(54) Packaging container

(76) Inventor: Jessica B. Cohen, Redwood City, CA (US)

Correspondence Address: CARR & FERRELL LLP, 2200 GENG ROAD, PALO ALTO, CA, 94303, US

(21) Appl. No.: 10/617,918

(22) Filed: Jul. 10, 2003

Related U.S. Application Data
(60) Provisional application No. 60/394,887, filed on Jul. 10, 2002.

(51) Int. Cl. A23B 4/00

(52) U.S. Cl. 426/108

(57) ABSTRACT

A substantially translucent packaging container includes two adjacent chambers: a first chamber for holding unprepared product and a second chamber for holding a sample or reasonable facsimile of the unprepared product in prepared form. The first chamber is sealed with a removable cap for ready access to the unprepared product, while the second chamber is generally not meant to be opened.

### CROSS-REFERENCE TO RELATED APPLICATIONS

This application claims the benefit of Provisional Patent Application Serial No. 60/394,887, filed Jul. 10, 2002, entitled “Packaging for Tea Leaves”, which is incorporated by reference.

### BACKGROUND OF THE INVENTION

1. Field of the Invention

The present invention is directed toward a packaging container for food goods such as tea. More particularly, the present invention is directed toward a packaging container for food goods which allows a consumer to view the food goods in both its prepared and unprepared forms.

2. Description of Related Art

Current tea packaging in the United States does not give enough sensory information to consumers to allow consumers to make informed purchasing decisions.

Applicant invented this packaging system for tea while researching the consumption of hot beverages among American consumers. Applicant interviewed a Chinese tea importer and manager of a tea house. The interviewee complained that American consumers do not understand the value or quality of tea, and that she needs to consistently educate Americans about tea. Interviewee understood tea as a very sensual, ritualistic experience, but found this difficult to communicate to her American customers. Interviewee observed that American consumers will pay for a high-grade wine or coffee, but not tea. From these and other observations, applicant concluded that the tea market in the U.S. is small in the U.S. not because of the product, tea leaves, but because of what certain mental associations with the product. Tea is considered a fine epicurean product in other countries, like China, but not in the U.S. American consumers cannot tell the difference between fine tea and lower grade teas, although they can distinguish among grades of other food products, such as wine and coffee. Creative packaging could help educate the consumer about the nature of the contents and the different grades of tea.

Applicant also noticed a problem with the tea importer's current packaging solution. Interviewee had designed a permanent display of a number of large glass jars with loose tea leaves on the top shelf of a cabinet, and then on all of the other shelves she placed smaller, 3-oz. cardboard containers of sealed tea leaves for sale. Applicant observed that when consumers wanted to purchase tea, they needed to first choose the tea they wanted by sight and smell (often by opening the glass jars). Then to purchase the tea, they needed to identify the name of the tea from the label on the glass jar and then match this name to a cardboard container.

Applicant also observed how tea is packaged in a more plebian grocery setting, in grocery stores. Most epicurean products at grocery stores offer some form of sensory information about the contents. For example, coffee beans can be seen or smelled though clear plastic dispensers. Olive oil is packaged in clear glass jars that allowed the consumer to see the color of the oil and also to sense its viscosity. Spices were packaged for the most part in clear jars. However without exception, the tea is packed in either paperboard boxes or tins. Traditionally tea is packaged in light-tight containers because of its tendency to spoil under exposure to sunlight. This type of packaging gives the consumer no sensory information about the contents of the box. Often the boxes are covered with graphics that do not relate to the taste, smell, or sight of the contents.

To the applicant these above examples clearly illustrate the need for more sensory information in tea packaging for American consumers. Applicant also saw the need for packaging for tea that communicated its worth as a fine epicurean product; and for packaging that in and of itself was special (as are perfume jars). It also illustrates the potential for such a new packaging system to increase bulk tea sales in the U.S. market.

### SUMMARY OF THE INVENTION

The present invention is directed towards a packaging container. The packaging container comprises a container made of a substantially translucent material, a wall dividing the container into a first chamber and a second chamber, the first chamber having sufficient size to accommodate an unprepared product, the first chamber having an opening wide enough to give access to the unprepared product, the second chamber designed to contain a prepared product, the second chamber being sealed except for a hole, a cap for sealing the first chamber during storage, and a plug to seal the hole.

### BRIEF DESCRIPTION OF THE DRAWINGS

FIGS. 1, 2 and 3 show one embodiment of a packaging container of the present invention.

FIGS. 4 and 5 show cross-sectional views of different embodiments of a packaging container of present invention.

FIG. 6 shows one embodiment of a packaging container of the present invention.

FIG. 7 shows a bottom view of one embodiment of a packaging container of the present invention.

FIGS. 8 and 9 show top views of one embodiment of a packaging container of the present invention, without and with a cap, respectively.

### DETAILED DESCRIPTION OF THE INVENTION

Applicant therefore invented a packaging system especially designed to market tea leaves to American consumers. The essential advantage of this packaging system over the prior art is that dry leaves and their product, tea brew, are placed next to each other in a single container. This system is designed to give the maximum amount of sensory information about tea leaves and brew, to educate and inform the consumer. It is also designed to raise the level of appreciation for tea as a fine epicurean product by displaying it as if it were a fine spice or perfume. Because of the variety in shape and color of tea leaves and liquid brew, placing such containers adjacent to each other creates a colorful and attractive visual display.

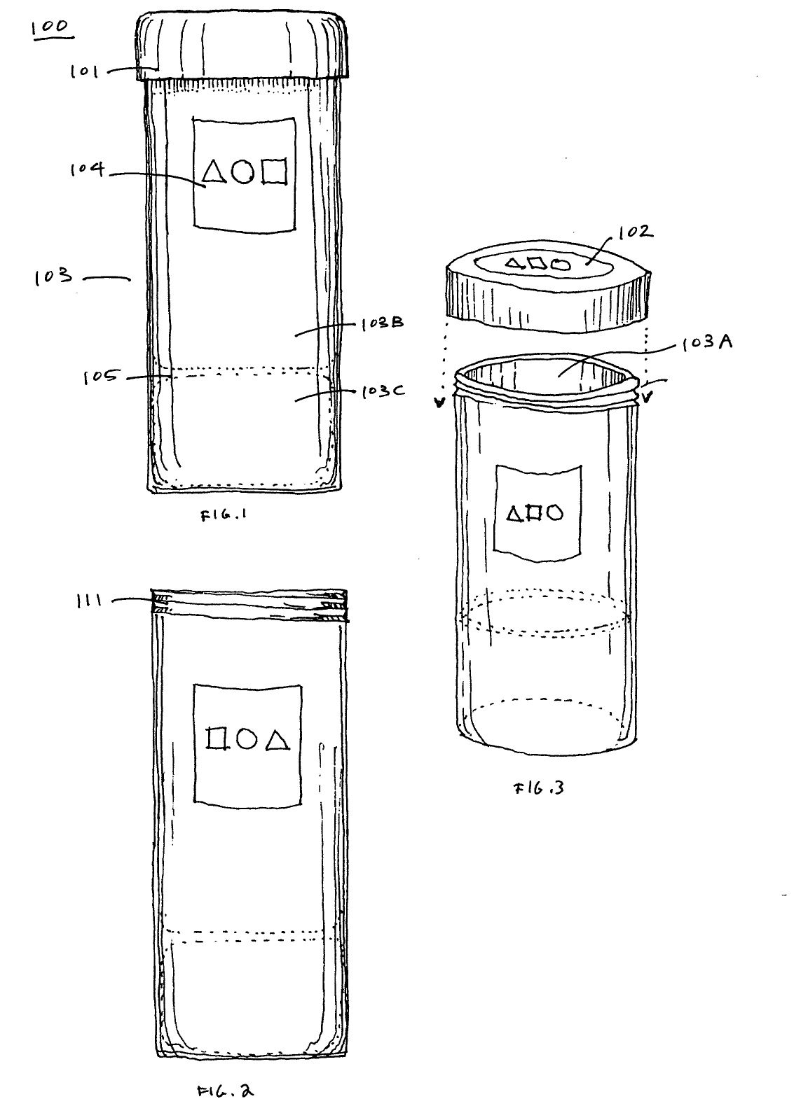

FIGS. 1, 2 and 3 show one embodiment of a packaging container 100 of the present invention. A cap 101 is meant to be rigid, food-safe, and removable from the container body 103. Cap 101 may be constructed of a material which is costeffective, food-safe, light-weight, and durable. Cap 101 may be affixed to the container body 103 in such as way so that the contents remain fresh, air-tight, and tamper-resistant while on shelf display. Container body 103 may contain threads 111, however, other methods of sealing cap 101 to container body 103 may be used, such as a latch mechanism or a fresh seal cover. Container body 103 may have an opening 103A which is sufficiently wide to allow easy spooning of the product. Opening 103A of container body 103 may be untapered so that the radius at the top of the container body 103 is not decreased and more difficult for a user to spoon out the contents.

Container body 103 may be constructed of a material which is rigid, durable, food-safe, and partially or fully transparent or translucent. Container body 103 may have a cylindrical profile, to promote ease of manufacturing and to give the consumer mental associations with other epicurean products, such as wine and spices, which are typically packaged in cylindrical vessels. However other shapes or profiles may be applied. Container body 103 may be made of a material which is tinted or coated to prevent exposing the contents to ultraviolet light.

A cap label 102 and a body label 104 may have graphics printed on them to give information about the product. Cap label 102 and body label 104 may be small in proportion to container body 103 so that consumers may see the contents of container body 103 more easily. However, any size or shape is acceptable, as long as the necessary product information is conveyed and that the consumer has a good sense of what the contents of container body 103. Cap label 102 and body label 104 may also be transparent, and thus stretch over the whole of container body 103.

Wall 105 may be a divider that has been molded or otherwise structurally sealed within container body 103. Wall 105 divides container body 103 into a product chamber 103B and a display chamber 103C, and makes a complete seal between these two chambers, allowing neither gas nor liquid nor solid to pass through.

For example, product chamber 103B may contain dry tea leaves, and display chamber 103C may contain liquid or tea brew. Display chamber 103C may also contain some of the brewed tea leaves to show what they look like after brewing, as some tea drinks are served with the original leaves in the brew. Wall 105 may be placed in different positions in relation to container body 103 to accommodate varying ratios of display to product contents.

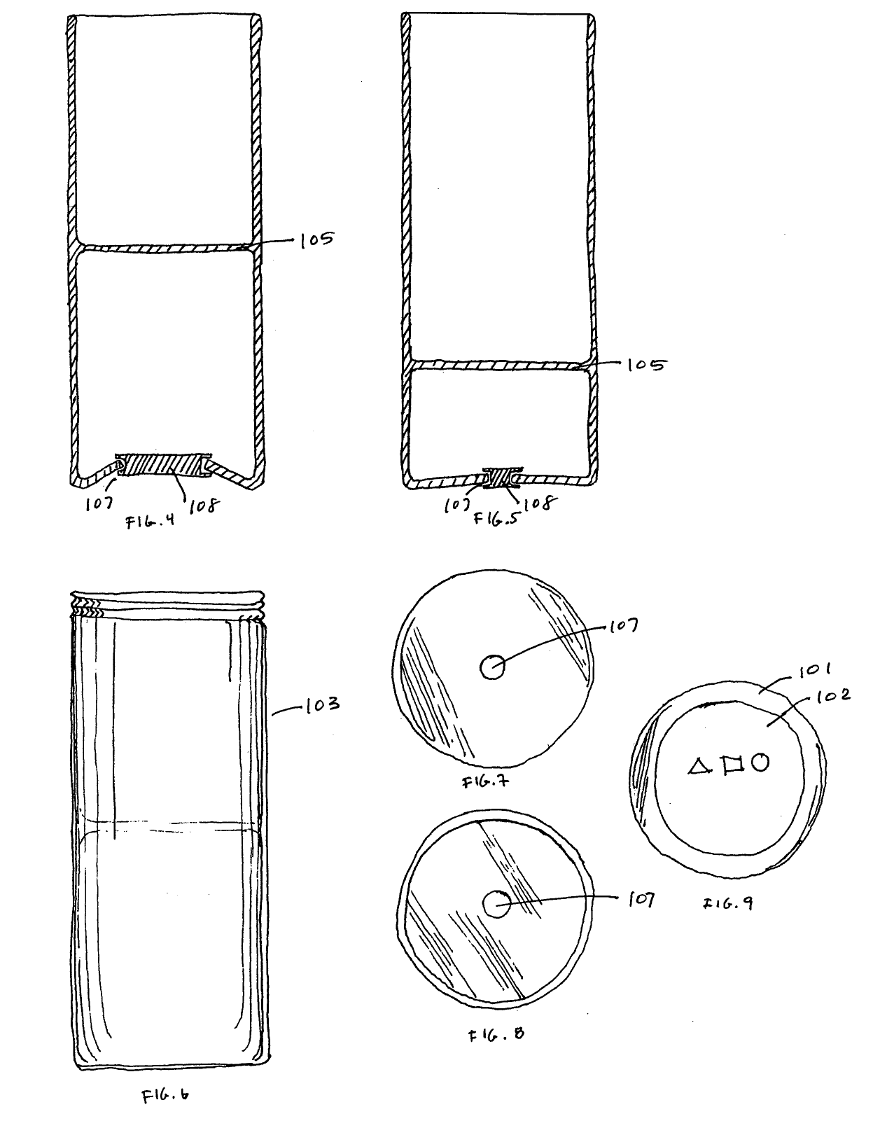

FIGS. 4 and 5 show cross-sectional views of two different embodiments of a packaging container of present invention. The display contents may be entered into display chamber 103C through a hole 107, and may be sealed in display chamber 103C by a plug 108. In the case that tea leaves or similar solids are placed into display chamber 103C, the size of hole 107 may be adjusted to accommodate the size of the leaves or solids. Hole 107 may be located at the bottom of display chamber 103C or any other location. Plug 108 may be of different sizes to accommodate hole 107. Hole 107 may also be sealed with a glue or other material instead of plug 108. Any display contents such as liquid may be meant for decoration and not necessarily for consumption. Should the display contents be placed in display chamber 103C such that plug 108 is facing a flat surface such as a shelf or the ground, then the surface of container body 103 that includes plug 108 may be slightly concave, so that container body 103 will stand stably upright.

FIG. 6 shows one embodiment of a packaging container of the present invention. FIG. 7 shows a bottom view of one embodiment of a packaging container of the present invention. FIGS. 8 and 9 show top views of one embodiment of a packaging container of the present invention, without and with a cap, respectively.

In operation one uses packaging container 100 in a normal manner. Much of the “work” performed by packaging container 100 occurs in its visual display as a marketing technique. A user may observe packaging container 100 in a retail setting, and glean information about its contents to make a much more informed purchasing decision than he or she would with standard product packaging.

For example, with tea leaves, in order to access the tea leaves, one holds packaging container 100 in one hand while removing cap 101 from the lip of the product chamber 103B with the other hand. Depending on the nature of the seal of cap 101, one may unscrew or pull off cap 101 from of the container body 103. One may the access the tea leaves by tilting packaging container 100 and pouring the leaves out, or by holding packaging container 100 upright, inserting a utensil such as a spoon into product chamber 103B of packaging container 100, and then scooping out the leaves with the utensil. After removing the desired quantity of tea leaves, one places cap 101 back onto product chamber 103B, in a manner dependent upon the type of seal used. After consuming all of the tea leaves, one may clean packaging container 100 and continue to use packaging container 100 as a drinking glass.

While the invention has been described in terms of some specific examples and in some specific embodiments, it will be clear that this invention is not limited to these specific examples and embodiments and that many changes and modified embodiments will be obvious to those skilled in the art without departing from the true spirit and scope of the invention as defined in the appended claims.

What is claimed is:

1. A packaging container comprising:
a container made of a substantially translucent material;
a wall dividing the container into a first chamber and a second chamber, the first chamber having sufficient size to accommodate an unprepared product, the first chamber having an opening wide enough to give access to the unprepared product, the second chamber designed to contain a prepared product, the second chamber being sealed except for a hole;
a cap for sealing the first chamber during storage; and
a plug to seal the hole.

2. The packaging container of claim 1 wherein the unprepared product is tea leaves.

3. The packaging container of claim 2 wherein the prepared product is a tea brewed from tea leaves substantially similar to those in the first chamber.

4. The packaging container of claim 2 wherein the prepared product is a liquid resembling a tea brewed from the tea leaves of the first chamber.

5. The packaging container of claim 1 wherein the container is resistant to ultraviolet light.

6. The packaging container of claim 1 wherein the container is coated with a material which is resistant to ultraviolet light.

7. The packaging container of claim 1 wherein the container includes a threaded lip.

8. The packaging container of claim 1 wherein the cap forms an airtight seal with the first chamber.

9. A method for packaging a food product, the method comprising:
providing a substantially translucent container having a first chamber and a second chamber, the first chamber being adjacent to the second chamber;
placing in the first chamber an unprepared product;
sealing the first chamber with a removable cap;
placing in the second chamber a prepared product corresponding to the unprepared product; and
sealing the second chamber with a substantially permanent seal.
